(19) United States
(12) Patent Application Publication
(10) Pub. No.: US 2018/0101858 A1
(43) Pub. Date: Apr. 12, 2018

(54) SYSTEM AND METHOD FOR PROVIDING REWARD POINTS

(71) Applicant: MasterCard International Incorporated, Purchase, NY (US)

(72) Inventors: Shweta Jain CHAUDHURY, London (GB); Randall K. SHUKEN, Westport, CT (US)

(73) Assignee: MasterCard International Incorporated, Purchase, NY (US)

(21) Appl. No.: 15/288,231

(22) Filed: Oct. 7, 2016

(51) Int. Cl. G06Q 30/02

(52) U.S. Cl. CPC G06Q 30/0227; G06Q 30/0238

(57) ABSTRACT

A method for providing reward points to a cross border consumer is described. The method includes determining a primary transaction area of a consumer, identifying the consumer as a cross border consumer based on the transactions conducted outside the primary transaction area (“foreign transaction”), and identifying a foreign merchant associated with the foreign transactions.

### FIELD

The present disclosure relates to a method and system for providing reward points, for instance, providing reward points for cross border transactions.

### BACKGROUND

Currently, financial institutions may provide loyalty programs to incentivize the cardholders to participate in certain purchase activities. These loyalty programs may include providing rebates, discounts, special handling, reward points, credit, etc., for certain types of transactions or for general account usage. For example, a credit card issuer may provide cash rebates or reward points when the cardholder uses the corresponding credit card to purchase goods generally, to purchase goods from specific types of merchants (e.g., grocery stores, restaurants, gas stations, etc.), or to purchase goods from specific merchants. The cardholder may use the cash rebates points for future purchases or may redeem the points or cash back for cash or other products.

However, many conventional loyalty programs often only allow the cardholder to receive the cash rebates, points, or other rewards for the transactions within the country where the cardholder registers the credit card. For instance, a cardholder who registers a credit card in the United States may receive points only from purchases in the United States, and may not receive points or redeem their points for purchases in France. Similarly, a loyalty program managed by a specific merchant may only allow the cardholder to earn points for domestic purchases, and may not allow the cardholder to earn or redeem points at locations outside of the cardholder's home country.

As such, there is a need for a technical solution to provide a method and system for providing reward points for cardholders that frequently participate in cross border transactions.

### SUMMARY

The present disclosure provides a description of systems and methods for calculating reward points based on cross border transactions. Such systems may enable a consumer to earn and redeem reward points or other incentives for purchases made outside of a local area, to both encourage and incentivize spending at foreign merchants. In addition, foreign merchants may receive increased exposure and revenue from cardholders outside of their own local area, where such systems may be traditionally unavailable for merchants that are unable to track or distinguish cross border spending of consumers.

A method for providing reward points may include receiving, by a receiving device of a processing server via a payment network, transaction data regarding multiple transactions performed by a consumer, wherein the transaction data associated with each of the multiple transactions at least includes location information of a point of sale of the respective transaction, time information of the respective transaction, and identification information of the consumer; determining, by a determination module of the processing server, a primary transaction area of the consumer based on the location information of the multiple transactions; identifying, by the determination module of the processing server, the consumer as a cross border consumer in response to a determination that at least a predetermined number of the multiple transactions were conducted outside the primary transaction area of the consumer over a predetermined time period; and identifying, by the determination module of the processing server, a foreign merchant associated with one or more of the transactions that were conducted outside the primary transaction area, wherein the foreign merchant receives communications regarding rewards of a home merchant associated with one or more transactions conducted within the primary transaction area of the consumer.

A system for providing reward points may include a receiving device of a processing server configured to receive, via a payment network, transaction data regarding multiple transactions performed by a consumer, wherein the transaction data associated with each of the multiple transactions at least includes location information of a point of sale of the respective transaction, time information of the respective transaction, and identification information of the consumer; and a determination module of the processing server configured to determine a primary transaction area of the consumer based on the location information of the multiple transactions, identify the consumer as a cross border consumer in response to a determination that at least a predetermined number of the multiple transactions were conducted outside the primary transaction area of the consumer over a predetermined time period, and identify a foreign merchant associated with one or more of the transactions that were conducted outside the primary transaction area, wherein the foreign merchant receives communications regarding rewards of a home merchant associated with one or more transactions conducted within the primary transaction area of the consumer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for providing reward points for cross border transactions in accordance with exemplary embodiments.

FIG. 2 is a block diagram illustrating the processing server of FIG. 1 for providing reward points for cross border transactions in accordance with exemplary embodiments.

FIG. 3 is a flow diagram illustrating a process for providing reward points for consumers involved in cross border transactions in accordance with exemplary embodiments.

FIG. 4 is a diagram illustrating the identification of cross border transactions in accordance with exemplary embodiments.

FIG. 5 is a flow chart illustrating an exemplary method for calculating reward points in accordance with exemplary embodiments.

FIG. 6 is a flow diagram illustrating the processing of a payment transaction in accordance with exemplary embodiments.

FIG. 7 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

### System for Providing Reward Points

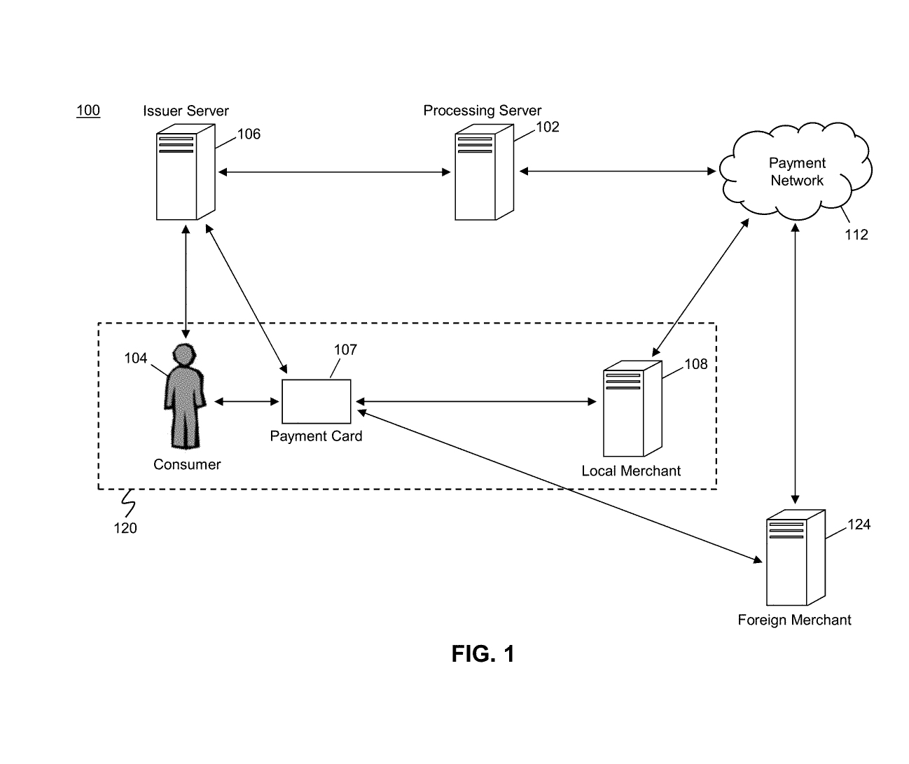

FIG. 1 is a block diagram illustrating a system 100 for providing reward points for cross border transactions in accordance with exemplary embodiments.

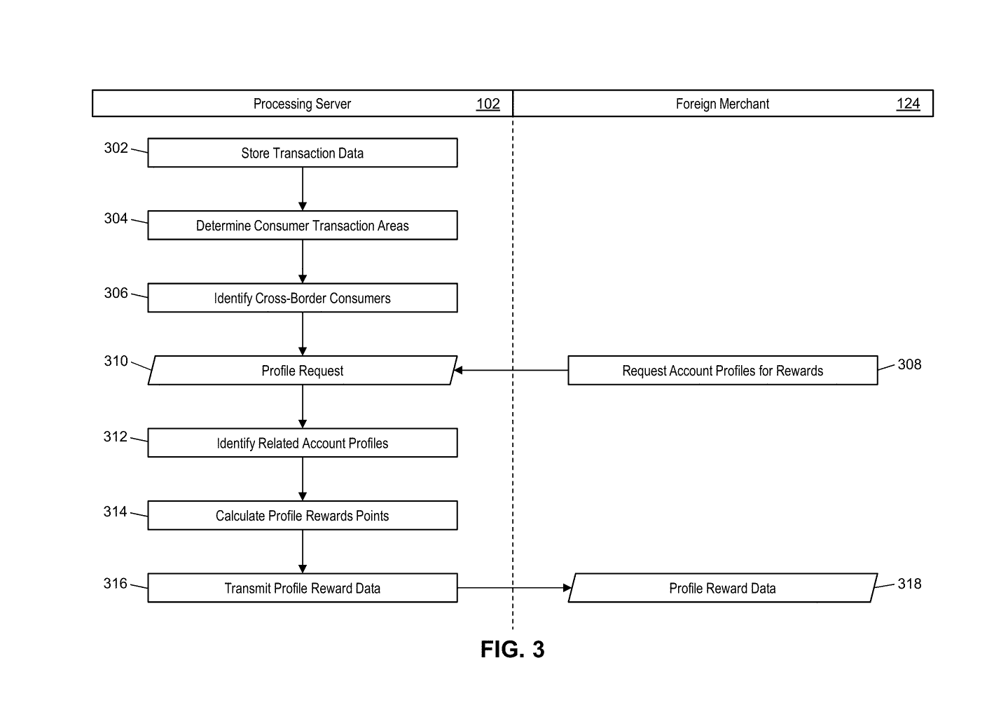

The system 100 may include a processing server 102 configured to provide reward points to a consumer 104 for cross border transactions. The consumer 104 may have a transaction account issued for use in funding payment transactions, which may be issued via an issuer server 106. The issuer server 106 may be a computing system associated with an issuing financial institution configured to issue transaction accounts to consumers 104 for funding payment transactions, such as an issuing bank. As part of the issuing of the transaction account, the issuer server 106 may issue a payment card 107 to the consumer 104. The payment card 107 may be encoded with or otherwise configured to store or access payment credentials for the associated transaction account. As depicted in greater detail with respect to FIG. 3, the consumer 104 may conduct a payment transaction using the payment card 107 at a local merchant 108. The local merchant 108 may be a merchant located in a primary transaction area 120 associated with the consumer 104. The primary transaction area 120 may be, as discussed in more detail below, a geographic area in which a majority or other predetermined amount of transactions involving the consumer 104 take place.

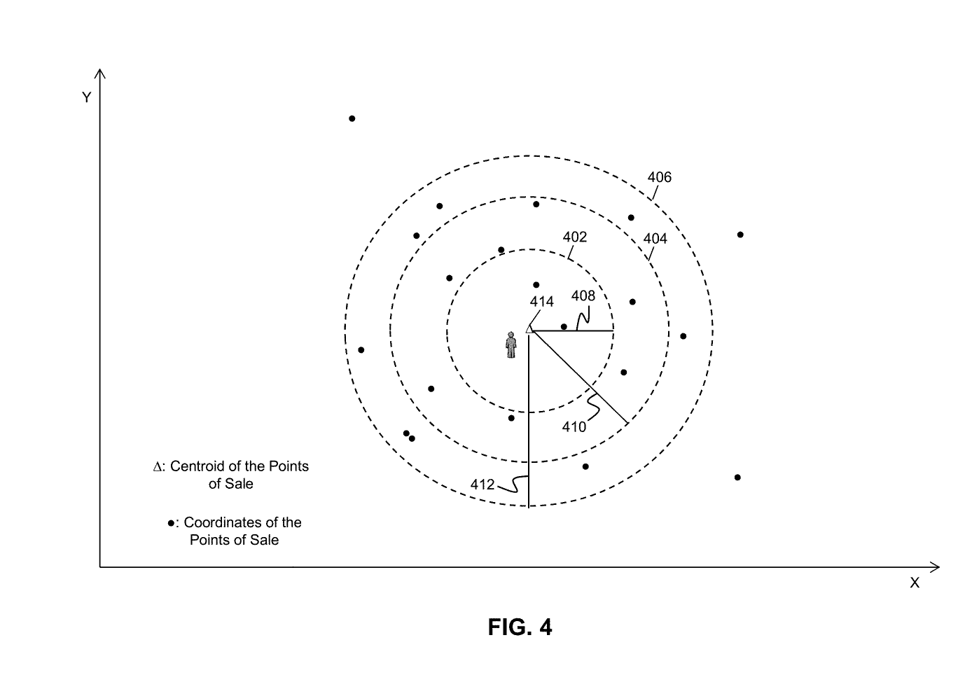

In a simplified example for payment transactions, the consumer 104 may initiate a payment transaction with the local merchant 108 using the payment card 107 or other suitable payment instrument. The local merchant 108 may receive payment credentials from the payment card 107 using any suitable method, such as by reading payment credentials encoded in a magnetic strip included in the payment card 107, receiving the payment credentials via an electronic transmission from the payment card 107 using near field communication, reading a machine-readable code displayed by the payment card 107 or other payment instrument that is encoded with the payment credentials, etc. For instance, in one example, the consumer 104 may use a computing device (e.g., a cellular phone, smart phone, smart watch, wearable computing device, implantable computing device, laptop computer, desktop computer, notebook computer, tablet computer, etc.) to electronically transmit payment credentials to the local merchant 108 via a point of sale, web site, or other suitable method. As discussed herein, the local merchant 108 may refer to a server or other computing system operated by a merchant conducting business within a primary transaction area 120 of the consumer 104, such as may include or be comprised of a point of sale system. The primary transaction area 120 of consumer 104 may be determined in accordance with the description in FIG. 4.

The local merchant 108 may receive the payment credentials from the payment card 107 for the transaction and, to initiate processing of the payment transaction, may electronically transmit the payment credentials and other transaction data to a payment network 112 for processing. The other transaction data may include any data suitable for use in the processing of a payment transaction, such as a transaction amount, transaction time, transaction date, geographic location, merchant name, merchant identification number, merchant category code, product data, issuer data, acquirer data, product data, consumer data, reward data, offer data, loyalty data, etc. The local merchant 108 may electronically transmit the transaction data directly to the payment network 112, or via one or more intermediate entities, such as an acquiring financial institution and/or gateway processor. The transaction data may be formatted in a transaction message, which may be formatted by the local merchant 108 or one of the intermediate entities, as applicable.

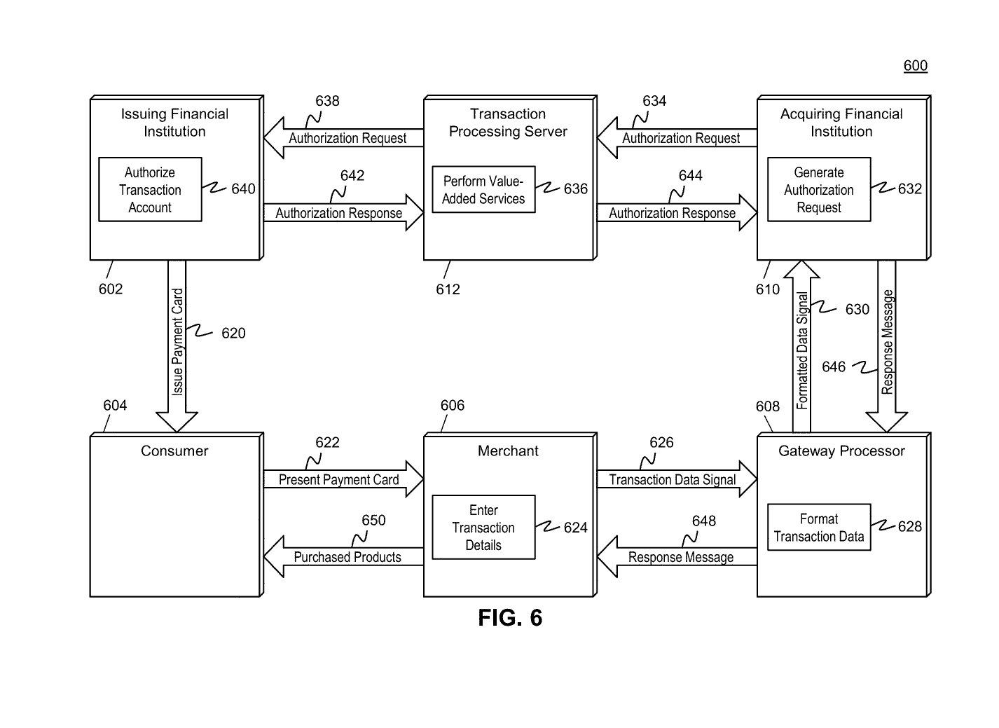

Transaction messages may be specially formatted data messages that are formatted pursuant to one or more standards governing the exchange of financial transaction messages, such as the International Organization for Standardization's ISO 8583 or ISO 20022 standards. Transaction messages may include a message type indicator indicative of a type of transaction message, such as an authorization request or authorization response, and a plurality of data elements. Each data element may be configured to store transaction data, such as a data element configured to store a primary account number, a data element configured to store the transaction amount, etc. In some instances, a transaction message may also include one or more bitmaps, which may be configured to indicate the data elements included in the transaction message and the data stored therein. Additional information regarding transaction messages, the transmission and formatting thereof, and use in the processing of payment transactions is discussed in more detail below with respect to the process 600 illustrated in FIG. 6.

The payment network 112 may receive the transaction message for the payment transaction, which may be formatted as an authorization request, and may process the payment transaction using traditional methods and systems. Such methods may involve the forwarding of the authorization request to the issuer server 106, which may determine approval or denial of the payment transaction, such as based on the transaction amount and available credit of the consumer 104. The issuer server 106 may return a transaction message formatted as an authorization response to the payment network 112 that includes a data element configured to store a response code indicating approval or denial of the payment transaction. The payment network 112 may forward the authorization response and/or data included therein to the local merchant 108 (e.g., via the one or more intermediate entities, as applicable), which may then finalize the payment transaction accordingly.

As described above, the financial institution that provides the payment card 107 to the consumer 104, associated with the issuer server 106, may implement loyalty programs for cardholders, e.g., the consumer 104. As an example of the loyalty programs, the financial institution may provide a portion of the transaction amount, or equivalent points, as rebates to the cardholder for future purchases. In a more specific example, the issuer server 106 may implement a loyalty or other reward program that allows the consumer 104 to receive rebates or points worthy of 5% of the transaction amount from every purchase transaction made by the consumer 104 at specific local merchants 108 or types of merchants in the country (e.g., the United States) or other area (e.g., greater Boston area) that may comprise the consumer's 104 primary transaction area 120. The consumer 104 may use the rebates or points for subsequent purchases of the same or other types of goods or services, for the receipt of cash back or other products, or other suitable uses of reward points or other rebates.

When a consumer 104 frequently travels to a foreign area (e.g., outside of their primary transaction area 120) and makes payment transactions with a foreign merchant 124, the consumer 104 may be identified as a cross border consumer. Foreign merchants 124 may be merchants (e.g., and any computing systems associated therewith, such as point of sale systems) that are located outside of the consumer's primary transaction area 120. In some instances, foreign merchants 124 may be located in a separate country from the consumer 104. In other instances, foreign merchants may be located in the same country as the consumer 104, but still outside of the primary transaction area 120, depending on the definition of the primary transaction area 120. As used herein, “cross border” may refer to actions performed by the consumer 104 outside of their primary transaction area 120, with the border referring to the demarcation of the primary transaction area 120. For instance, the border may be a country border, border of a municipal area, a circle surrounding a centroid identified for the consumer 104 based on their transaction history, etc. Similar to the transaction process in primary transaction area 120, the foreign merchant 124 may electronically transmit transaction data to the payment network 112 in a transaction message for processing using traditional methods and systems of the payment network 112.

The processing server 102, discussed in more detail below, may be configured to provide reward points, rebates, or other incentives to the consumer 104 for cross border transactions, such as transactions involving foreign merchants 124. In some embodiments, the processing server 102 may be a part of the issuer server 106 and may be configured to operate loyalty programs offered by the issuer server 106 for cross border consumers. In other embodiments, the processing server 102 may be external to the issuer server 106 and may manage cross border rewards and communicate with the issuer server 106 regarding such rewards using electronic transmissions to and from the issuer server 106 via a suitable communication network and method. In such embodiments, the processing server 102 may receive transaction data from the issuer server 106 for cross border payment transactions involving cross border consumers, or may receive transaction messages directly from the payment network 112. In some such embodiments, the processing server 102 may be a part of the payment network 112.

### Processing Server

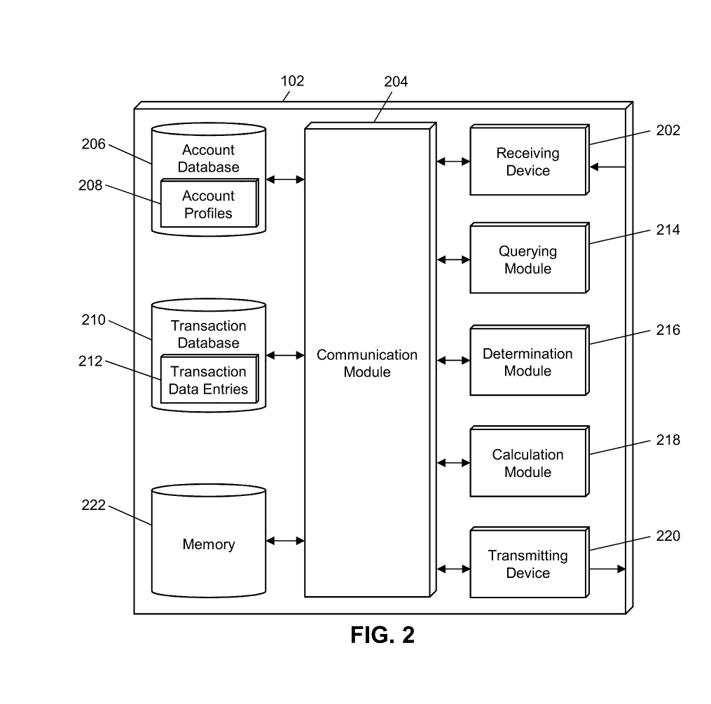

FIG. 2 is a block diagram illustrating processing server 102 of FIG. 1 for providing reward points for cross border transactions in accordance with exemplary embodiments.

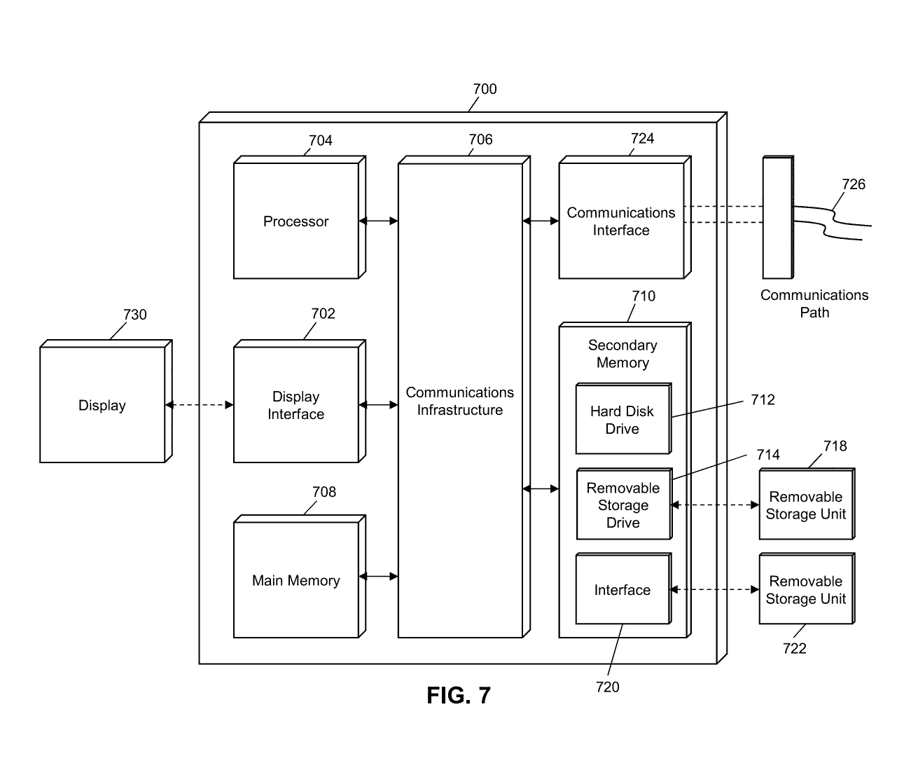

It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration for processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from issuer servers 106, local merchants 108, payment networks 112, foreign merchants 124, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuer servers 106 and payment networks 112, such as may be superimposed or otherwise encoded with transaction data and/or transaction messages. The receiving device 202 may also be configured to receive data signals electronically transmitted by local merchants 108 and/or foreign merchants 124, which may be superimposed or otherwise encoded with requests for reward data. Such requests may request reward information or consumer information for cross border consumers 104, such as for use in providing opportunities for redemption to cross border consumers 104. The receiving device 202 may also receive data signals from issuer servers 106 superimposed or otherwise encoded with requests for reward data for consumers 104 associated therewith, for operating of associated loyalty programs.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, determination module 216, calculation module 218, etc. As used herein, the term “module” may be software or hardware particularly programmed to receive an input, perform one or more processes using the input, and provide an output. The input, output, and processes performed by various modules will be apparent to one skilled in the art based upon the present disclosure.

In an example embodiment, processing server 102 may be configured to store account profiles 208 in account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a consumer 104. In some instances, each of the account profiles 208 may be associated with a consumer 104 identified as a cross border consumer. Each of the account profiles 208 may include data associated with a transaction account issued to the related consumer 104. The data associated with the transaction account may include at least identification information of the transaction account (e.g., the transaction account number and/or identifier) and a reward value. The reward value included in the data set may refer to available rebates or points that the cardholder received from previous transactions for future transactions. The reward value may be interchangeably referred to as “account balance” or “reward balance” hereinafter. In some instances, the account profile 208 may also include transaction data related to payment transactions involving the related consumer 104. In some cases, an account profile 208 may also include location data, such as the consumer's primary transaction area 120, a centroid associated with the related consumer 104 for use in identifying their primary transaction area 120, etc.

In some implementations of the example embodiment, processing server 102 may be configured to store one or more criteria for determining a primary transaction area, such as in a memory 222. The criteria may include, for example, a predetermined percentage of points of sale and a predetermined radius. The processing server 102 may further store other criteria for identifying a cross border consumer. For example, the criteria for identifying a cross border consumer may include a predetermined number of transactions and a predetermined time period. The processes of determining the primary transaction area and identifying a cross border consumer are described in greater detail below.

In some embodiments, the processing server 102 may also include a transaction database 210. The transaction database 210 may be configured to store a plurality of transaction data entries 212 using a suitable data storage format and schema. The transaction database 206 may be a relational database that utilizes structured query language for the storage, identification, modifying, updating, accessing, etc. of structured data sets stored therein. Each transaction data entry 212 may include data related to a payment transaction. In some instances, a transaction data entry 212 may include or be comprised of a transaction message. The data included in a transaction data entry 212 may be transaction data for the related payment transaction, which may include, for example, a primary account number, transaction amount, transaction time, transaction date, geographic location, merchant data, etc.

The processing server 102 may include a querying module 214. The querying module 214 may be configured to execute queries on databases to identify information. The querying module 214 may receive one or more data values or query strings, and may execute a query string based thereon on an indicated database, such as the account database 206, to identify information stored therein. The querying module 214 may then output the identified information to an appropriate engine or module of the processing server 102 as necessary. The querying module 214 may, for example, execute a query on the account database 206 to identify an account profile 208 associated with a received transaction message, which may be identified based on a correspondence between a primary account number stored in the account profile 208 and the primary account number stored in the corresponding data element included in the transaction message. In another example, the querying module 214 may be configured to identify account profiles 208 for cross border consumers as requested by a merchant based on primary transaction areas 120 included in the account profiles 208 that consider the merchant a foreign merchant 124.

The processing server 102 may also include a determination module 216. The determination module 216 may be configured to make determinations for the processing server 102 for performing the functions of the processing server 102 as discussed herein, such as determining the primary transaction area 120 for a consumer 104, determining if a consumer 104 is a cross border consumer, determining reward points for cross border transactions for a consumer 104, etc. The determination module 216 may receive data and instructions related thereto, may make a determination in accordance with the data and instructions, and output the determination to another module or engine of the processing server 102. For example, the determination module 216 may receive a plurality of transaction messages for a consumer 104 or account profile 208, may determine the primary transaction area 120 for the consumer 104, and may output the primary transaction area 120 to another module of the processing server 102, such as the querying module 214 for inserting into the account profile 208 via a query on the account database 206. The determination module 216 may also be configured to determine if a consumer 104 is a cross border consumer, which may be based on transactions involving the consumer 104 that are cross border transactions. A transaction may be a cross border transaction if the geographic location included in a corresponding transaction message and/or the merchant involved in the transaction is located outside of the primary transaction area 120 associated with the involved consumer 104. The consumer 104 may be considered a cross border consumer if a predetermined number of their payment transactions are determined to be cross border transactions. The predetermined number may be, for example, an integer (e.g., 10 cross border transactions) or a percentage (e.g., 5% of total transactions), and, in some instances, may also have a time-based criteria, such as a number of cross border transactions during a predetermined period (e.g., 10 cross border transactions every 6 months, 5% of yearly transactions being cross border, etc.).

The processing server 102 may also include a calculation module 218. The calculation module 218 may be configured to perform calculations for the processing server 102 for performing the functions of the processing server 102 as discussed herein. The calculation module 218 may receive instructions and data associated therewith, may perform the requested calculations, and may output a result of the calculations to another module or engine of the processing server 102. The calculation module 218 may, for example, calculate a centroid for a consumer 102 based on the geographic location of each of their payment transactions, as identified in the transaction data entry 212 or transaction message associated therewith. The calculation module 218 may also be configured to calculate a primary transaction area 120 for a consumer 102 that includes a predetermined number (e.g., integer or percentage) of their payment transactions, which may be based on the centroid. For instance, the calculation module 218 may identify a radius that, when a circle is drawn with that radius around the centroid, captures the predetermined number of payment transactions, such as discussed in more detail below with respect to FIG. 4. The calculation module 218 may also be configured to calculate reward points for cross border transactions using algorithms or equations that will be apparent to persons having skill in the relevant art.

The processing server 102 may also include a transmitting device 220. The transmitting device 220 may be configured to transmit data over one or more networks via one or more network protocols. In some embodiments, the transmitting device 220 may be configured to transmit data over the payment rails, such as using specially configured infrastructure associated with payment networks 112 for the transmission of transaction messages that include sensitive financial data and information, such as identified payment credentials. In some instances, the transmitting device 220 may be configured to transmit data to issuer servers 106, local merchants 108, foreign merchants 124, payment networks 112, and other entities via alternative networks, such as the Internet. In some embodiments, the transmitting device 220 may be comprised of multiple devices, such as different transmitting devices for transmitting data over different networks, such as a first transmitting device for transmitting data over the payment rails and a second transmitting device for transmitting data over the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to issuer servers 106, local merchants 108, and foreign merchants 124 that are superimposed or otherwise encoded with reward data. The reward data may include reward points and corresponding transaction account identifiers or contact information for cross border consumers. In some instances, reward data may also include additional data associated with a cross border consumer, such as consumer merchant preferences, their primary transaction area 120, and other data that may be used by an issuer server 106, local merchant 108, or foreign merchant 124 in the administration of a reward program or offering of incentives or redemption options to a consumer 104. In some embodiments, the transmitting device 220 may be configured to electronically transmit transaction messages, such as to the issuer server 106 and/or payment network 112 for the processing of payment transactions.

The processing server 102 may also include a memory 222. The memory 222 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 222 may be comprised of or may otherwise include a relational database that utilizes structured query language for the storage, identification, modifying, updating, accessing, etc. of structured data sets stored therein.

### Process for Providing Reward Data for Cross Border Consumers

FIG. 3 is a flow diagram illustrating the process 300 of providing reward points in accordance with exemplary embodiments.

In step 302, the processing server 102 may store a transaction data for a plurality of payment transactions in account profiles 208 associated therewith in an account database 206. Transaction data may be obtained via the receipt by the receiving device 302 of the processing server of transaction messages electronically transmitted via the payment network 112 using payment rails associated therewith. In step 304, the determination module 216 of the processing server 102 may determine a primary transaction area 120 for each of the account profiles 208 in the account database 206 based on the geographic location of each of the payment transactions included in the respective account profile 208. In some embodiments, the country or other predefined geographic area where the related consumer 104 registers the related transaction account may be determined to be the primary transaction area 120. Alternatively, the determination module 216 may be configured to determine the boundary of primary transaction area 120 based on the various locations of the points of sale of the multiple transactions in accordance with the description regarding FIG. 4.

In step 306, the determination module 216 may identify cross border consumers based on their determined primary transaction areas 120 and the amount of transactions associated therewith that are conducted outside the respective primary transaction area 120. As part of the identification, the determination module 216 may identify transactions that involve a consumer 104 outside of their primary transaction area 120, i.e., foreign transactions. That is, the determination module 216 may be configured to compare the location information of the point of sale of a respective transaction to the primary transaction area 120 to determine whether the respective transaction was conducted outside of the primary transaction area 120. If a transaction was determined to be conducted outside primary transaction area 120, the transaction may be identified a foreign transaction. The determination module 216 may then identify if at least a predetermined number of transactions were conducted outside the primary transaction area 120 over a predetermined time period. For example, the determination module 216 may be configured to determine that fifty three of the multiple transactions were conducted by consumer 104 outside primary transaction area in the past one month while the predetermined number is forty. Since the amount of foreign transactions exceeds the predetermined number in the past month, the determination module 216 may identify that consumer 104 as a cross border consumer.

In step 308, a foreign merchant 124 may electronically transmit a request for account profiles to the processing server 102 via a suitable communication network and method. In step 310, the receiving device 202 of the processing server 102 may receive the request. The request may include at least the geographic location of the foreign merchant 124 and may, in some instances, include criteria for the filtering of account profiles 208. For example, the foreign merchant 124 may request profiles only for cross border consumers, for consumers that have cross border transactions involving a specific merchant industry, for consumers that have a predetermined number of transactions involving the specific merchant industry, etc. In step 312, the querying module 214 of the processing server 102 may execute a query on the account database 206 to identify account profiles 208 based on the criteria included in the received request.

In step 314, the calculation module 218 of the processing server 102 may calculate the foreign reward points for each of the identified account profiles 208 based on one or more foreign transactions, e.g., based on the transaction amount of the foreign transactions. In an example embodiment, the calculation module 218 may be configured to calculate the foreign reward points for the respective consumer 104 in accordance with an algorithm. For example, the algorithm may indicate that, for every dollar spent in the foreign transactions, one reward point may be generated for the consumer 104. In some embodiments, the algorithm may also be used for calculating domestic reward points that refer to the reward points generated or calculated based on domestic transactions, e.g., transactions occurred within primary transaction area 120.

In step 316, the transmitting device 220 of the processing server 102 may electronically transmit a data signal to the foreign merchant 124 that is superimposed or otherwise encoded with the identified account profiles 208 and/or data included therein, such as the calculated reward points, transaction data, contact information, etc. In step 318, the foreign merchant 124 may receive the profile data. The foreign merchant 124 may then use the profile data to, for example, offer redemption opportunities for the related consumers 104, advertise to the related consumers 104, develop marketing based on the related consumers 104, etc.

### Process for Determining a Primary Transaction Area

FIG. 4 is diagram illustrating the process for identifying a primary transaction area 120 for a consumer 104 in accordance with exemplary embodiments.

For purpose of illustration, locations (e.g., coordinates) of the points of sale of the multiple transactions are represented by solid round dots in FIG. 4. Based on the coordinates of the points of sale, the determination module 216 of the processing server 102 may be configured to calculate a centroid of the coordinates of the points of sale. The centroid may be represented by A 414 and determined to be a center of a circle 402 with a predetermined radius 408 (e.g., 20 miles). The determination module 216 may be further configured to determine whether the circle 402 encompasses at least a predetermined percentage (e.g., 80%) of the points of sale. If so, the area encompassed by the circle 402 may be determined to be primary transaction area 120. If not, determination module 216 may increase the radius of the circle by a predetermined amount (e.g., 3 miles), e.g., to be the radius 410, to determine whether the new circle 404 with the increased radius encompasses at least a predetermined percentage of the points of sales. The above operations may be repeatedly performed until the circle encompasses a predetermined percentage of the points of sale. In the example illustrated in FIG. 4, the process may be continued until radius 412 is used to obtain the circle 416, which may encompass the predetermined amount of points of sale.

As such, in some embodiments the primary transaction area 120 may not refer to the country in which consumer 104 registers their transaction account. Rather, the primary transaction area 120 may refer to a circle 406 with 20 miles radius from the centroid 414 of the locations of the points of sale for payment transactions involving the consumer 104. Thus, when consumer 104 enjoys reward points from a franchise grocery store near his/her primary home (e.g., greater Boston area), the consumer 104 may also receive reward points when he/she travels to a foreign transaction area (e.g., California) and shops for grocery at a local food market therein.

### Exemplary Method for Calculating Reward Points

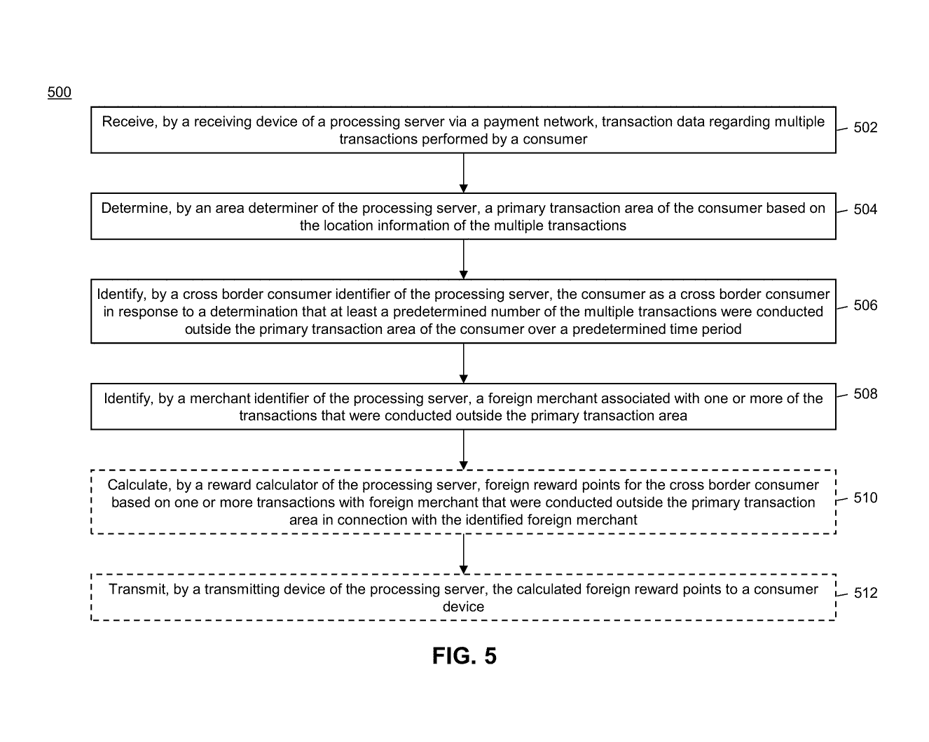

FIG. 5 illustrates a process 500 for calculating reward points for cross border transactions in accordance with exemplary embodiments.

At 502, a receiving device (e.g., the receiving device 202) of a processing server (e.g., the processing server 102) may be configured to receive data over one or more networks via one or more network protocols. In some implementations, receiving device 202 may be configured to receive data over the payment rails explained in relation to FIG. 6, such as using specially configured infrastructure associated with a payment network (e.g., the payment network 112) for the transmission of transaction data that include sensitive financial data and information. In some instances, receiving device may be configured to receive, via payment network, a transaction message that includes transaction data associated with the multiple transactions performed by a consumer (e.g., the consumer 104). The transaction message may be formatted based on one or more standards (e.g., ISO 8583 or ISO 20022) and may include a plurality of data elements respectively configured to store a primary account number, a transaction amount, and additional transaction data including the subject of the transaction, the volume of the transaction, the category of the subject, merchant category code, merchant identifier, location information of a point of sale of the respective transaction, payment method, acquirer identifier, issuer identifier, time information of the respective transaction, identification information of the consumer, location where the consumer registers the involved transaction account, etc. The primary account number may refer to the account number of consumer's transaction account and the transaction amount may refer to the total price of the current transaction.

At 504, upon receiving the transaction message, a determination module (e.g., the determination module 216) of the processing server may be configured to determine a primary transaction area (e.g., the primary transaction area 120) of the consumer based on the location information of the multiple transactions. For example, the determination module may be configured to determine the boundary of the primary transaction area based on the various locations of the points of sale of the multiple transactions in accordance with the description regarding FIG. 4.

At 506, based on the determined primary transaction area, the determination module may be configured to identify the consumer as a cross border consumer. In more detail, the determination module may first be configured to identify foreign transactions among the multiple transactions by comparing the location information of the point of sale of each transaction with the determined primary transaction area. If the transaction data indicates that a transaction is conducted at a point of sale outside the primary transaction area, the transaction may be identified as a foreign transaction. The determination module may then be configured to determine whether at least a predetermined number of the multiple transactions are foreign transactions. The predetermined number, as described above, may be previously stored in a memory (e.g., the memory 224) of the processing server. In response to a determination that the number of foreign transactions exceeds the predetermined number, the determination module may identify the consumer as a cross border consumer.

At 508, the determination module of the processing server may be configured to identify a foreign merchant (e.g., foreign merchants 124) associated with each of the foreign transactions. In an example embodiment, a foreign merchant may have received communications regarding rewards of a home merchant. For example, the foreign merchant may have entered into an agreement with a home merchant agreeing to accept the reward points that the consumer received via the transactions with the home merchant and/or to issue reward points based a same algorithm that is used by the home merchant in issuing reward points. Further to the example embodiment, the foreign merchant and the home merchant may be in the same merchant category, e.g., luxury goods provider. As such, a consumer who shops for luxury goods in foreign luxury stores may receive the same reward points as she/he does at the domestic luxury stores. In another example, the foreign merchant and the home merchant are in different merchant categories, e.g., restaurants and vineyards. Thus, a consumer who enjoys fine dining in a primary transaction area may receive reward points when she/he purchases wine outside of the primary transaction area.

Optionally, at 510, a calculation module (e.g., the calculation module 218) of the processing server may be configured to calculate the foreign reward points for the consumer based on one or more foreign transactions, e.g., based on the transaction amount of the foreign transactions. In an example embodiment, the calculation module may be configured to calculate the foreign reward points for the consumer in accordance with an algorithm. For example, the algorithm may indicate that, for every dollar spent in the foreign transactions, one reward point may be generated for the consumer. In some embodiments, the algorithm may also be used for calculating domestic reward points that refer to the reward points generated or calculated based on domestic transactions, e.g., transactions occurred within the primary transaction area. Optionally still, at 512, when the foreign reward points are calculated, a transmitting device (e.g., the transmitting device 220) of the processing server may be configured to transmit the foreign reward points to consumer device associated with the consumer.

### Payment Transaction Processing System and Process

FIG. 6 is a flow diagram illustrating the processing of a payment transaction in accordance with exemplary embodiments.

The process 600 and steps included therein may be performed by one or more components of the system 100 discussed above, such as the processing server 102, consumer 104, issuer server 106, payment card 107, local merchant 108, payment network 112, foreign merchant 124, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3, and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 670, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 is a block diagram illustrating a computer system architecture in accordance with exemplary embodiments.

For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 5, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for calculating reward points for cross border transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for calculating reward points, comprising:
receiving, by a receiving device of a processing server, transaction data regarding multiple transactions performed by a consumer, wherein the transaction data associated with each of the multiple transactions at least includes:
location information of a point of sale of the respective transaction,
time information of the respective transaction, and
identification information of the consumer;
determining, by a determination module of the processing server, a primary transaction area of the consumer based on the location information of the multiple transactions;
identifying, by the determination module of the processing server, the consumer as a cross boarder consumer in response to a determination that at least a predetermined number of the multiple transactions were conducted outside the primary transaction area of the consumer over a predetermined time period; and
identifying, by the determination module of the processing server, a foreign merchant associated with one or more of the transactions that were conducted outside the primary transaction area, wherein the foreign merchant receives communications regarding rewards of a home merchant associated with one or more transactions conducted within the primary transaction area of the consumer.

2. The method of claim 1, wherein the transaction data associated with each of the multiple transactions further includes a merchant category.

3. The method of claim 2, wherein the identifying the foreign merchant is performed by the determination module based on the merchant category of the home merchant.

4. The method of claim 3, wherein the foreign merchant and the home merchant are not in a same merchant category.

5. The method of claim 1, wherein the determining the primary transaction area includes determining, by the determination module of the processing server, a geographic area that encompasses a predetermined percentage of the points of sale of the multiple transactions based on the location information of the points of sale.

6. The method of claim 1, wherein the determining the primary transaction area includes
calculating, by a calculation module of the processing server, a centroid of the multiple points of sale;
determining, by the determination module of the processing server, the centroid as a center of a circle;
repeatedly increasing a radius of the circle by a predetermined amount until the circle encompasses a predetermined percentage of the points of sale of the multiple transactions; and
determining, by the determination module of the processing server, an area within the circle as the primary transaction area.

7. The method of claim 1, further comprising calculating, by a calculation module of the processing server, domestic reward points for the cross broader consumer based on a total domestic transaction amount of the transactions that were conducted within the primary transaction area in accordance with an algorithm used for calculating the foreign reward points.

8. The method of claim 1, further comprising transmitting, by a transmitting device of the processing server to the consumer device, an inquiry of enrollment that inquires the consumer whether the consumer is interested in receiving the foreign reward points.

9. The method of claim 1, further comprising calculating, by a calculation module of the processing server, foreign reward points for the cross boarder consumer based on one or more transactions that were conducted outside the primary transaction area in connection with the identified foreign merchant.

10. The method of claim 9, further comprising transmitting, by a transmitting device of the processing server, the calculated foreign reward points to a consumer device.

11. A processing server for calculating reward points, comprising
a receiving device of the processing server configured to receive, via a payment network, transaction data regarding multiple transactions performed by a consumer, wherein the transaction data associated with each of the multiple transactions at least includes:
location information of a point of sale of the respective transaction,
time information of the respective transaction, and
identification information of the consumer; and
a determination module of the processing server configured to
determine a primary transaction area of the consumer based on the location information of the multiple transactions,
identify the consumer as a cross boarder consumer in response to a determination that at least a predetermined number of the multiple transactions were conducted outside the primary transaction area of the consumer over a predetermined time period, and
identify a foreign merchant associated with one or more of the transactions that were conducted outside the primary transaction area, wherein the foreign merchant receives communications regarding rewards of a home merchant associated with one or more transactions conducted within the primary transaction area of the consumer.

12. The system of claim 11, wherein the transaction data associated with each of the multiple transactions further includes a merchant category.

13. The system of claim 12, wherein the merchant identifier is configured to identify the foreign merchant based on the merchant category of the home merchant.

14. The system of claim 13, wherein the foreign merchant and the home merchant are not in a same merchant category.

15. The system of claim 11, wherein the determination module of the processing server is further configured to determine a geographic area that encompasses a predetermined percentage of the points of sale of the multiple transactions based on the location information of the points of sale for determining the primary transaction area.

16. The system of claim 11, wherein the primary transaction area is within a border of a country, a state, a province, a county, or a city.

17. The system of claim 11, further comprising a calculation module of the processing server configured to calculate domestic reward points for the cross broader consumer based on a total domestic transaction amount of the transactions that were conducted within the primary transaction area in accordance with an algorithm used for calculating the foreign reward points.

18. The system of claim 11, further comprising a transmitting device of the processing server configured to transmit an inquiry of enrollment that inquires the consumer whether the consumer is interested in receiving the foreign reward points.

19. The system of claim 11, further comprising a calculation module of the processing server configured to calculate foreign reward points for the cross boarder consumer based on one or more transactions that were conducted outside the primary transaction area in connection with the identified foreign merchant.

20. The system of claim 11, further comprising a transmitting device of the processing server configured to transmit the calculated foreign reward points to a consumer device via the payment network.
